(19) United States
(12) Patent Application Publication
(10) Pub. No.: US 2008/0023983 A1
(43) Pub. Date: Jan. 31, 2008

(54) Method of manufacturing a trim panel assembly for a vehicle door

(75) Inventors: Randy S. Reed, Fair Haven, MI (US); Todd L. DePue, Brighton, MI (US); David J. Dooley, Troy, MI (US); Richard D. George, Rochester Hills, MI (US)

Correspondence Address: INTERNATIONAL AUTOMOTIVE COMPONENTS GROUP, LLC;c/o MACMILLAN, SOBANSKI & TODD, LLC, ONE MARITIME PLAZA, FIFTH FLOOR, 720 WATER STREET, TOLEDO, OH, 43604, US

(73) Assignee: Lear Corporation

(21) Appl. No.: 11/495,283

(22) Filed: Jul. 28, 2006

(51) Int. Cl. B60J 5/00

(52) U.S. Cl. 296/146.7

(57) ABSTRACT

A trim panel assembly includes a first trim panel and a second trim panel. The first trim panel has an attachment portion, and the second trim panel has an attachment portion that cooperates with the attachment portion of the first trim panel to connect the first and second trim panels together to provide a trim panel assembly that allows relatively sliding movement between the first and second trim panels. The first trim panel can have a single attachment portion that extends continuously throughout the length thereof, while the second trim panel can have a plurality of discrete portions that extends along the length thereof, or vice versa. The attachment portion of the second trim panel can be molded either about or within the attachment portion of the first trim panel.

### BACKGROUND OF THE INVENTION

This invention relates in general to a method of manufacturing a trim panel assembly for a vehicle door. In particular, this invention relates to an improved method of manufacturing such a vehicle trim panel assembly wherein a pre-molded first trim panel is inserted within a mold and a second trim panel is molded about portions of the first trim panel.

Trim panel assemblies are often provided within the interiors of vehicles to enhance the aesthetic appearance thereof. To accomplish this, trim panel assemblies can be provided in a variety of finishes to match or accent the other portions of the interior of the vehicle. For example, trim panel assemblies may be covered by a plastic-based material such as vinyl, fabric, or other material backed with a soft foam to provide a softer feel to the trim panel assembly. Trim panel assemblies can additionally serve a variety of functional purposes. For example, trim panel assemblies are provided for covering various vehicle mechanisms, such as door opening linkages, vehicle wiring, heating and air conditioning ducts, and instrument clusters. Additionally, trim panel assemblies can be provided with storage pockets to facilitate the storage of a variety of items, such as maps, coins, sunglasses, and the like. Lastly, trim panel assemblies can also include other passenger comfort features, such as armrests and beverage holders. Typically, such trim panel assemblies are typically supported on the interior framework and structural components of a vehicle and face the interior of the passenger compartment. For example, trim panel assemblies can be included in interior door panels, knee bolsters, instrument panels, consoles, headliners, pillar enclosures, and quarter panels.

Trim panel assemblies of this general type are commonly manufactured from the assembly of several individual trim panels. Some trim panel assemblies are manufactured from combining a first trim panel and a second panel. In these instance, the first trim panel and the second trim panel are initially formed as separate pieces. Then, the first trim panel and the second panel are connected together by any one of several well known fastening methods, including heat staking, wire nuts, clips, or other mechanical attachment mechanisms. Although this manufacturing process has been effective, the need for the secondary operation to connect the first trim panel and the second trim panel together has been found to be relatively expensive and somewhat inefficient. Thus, it would be desirable to provide an improved method of manufacturing such a vehicle trim panel assembly that is less expensive and more efficient.

### SUMMARY OF THE INVENTION

This invention relates to an improved method of manufacturing a vehicle trim panel assembly wherein a pre-molded first trim panel is inserted within a mold and a second trim panel is molded about portions of the first trim panel to form the trim panel assembly. The trim panel assembly includes a first trim panel and a second trim panel. The first trim panel has an attachment portion, and the second trim panel has an attachment portion that cooperates with the attachment portion of the first trim panel to connect the first and second trim panels together to provide a trim panel assembly that allows relatively sliding movement between the first and second trim panels. The first trim panel can have a single attachment portion that extends continuously throughout the length thereof, while the second trim panel can have a plurality of discrete portions that extends along the length thereof, or vice versa. The attachment portion of the second trim panel can be molded either about or within the attachment portion of the first trim panel.

Various objects and advantages of this invention will become apparent to those skilled in the art from the following detailed description of the preferred embodiments, when read in light of the accompanying drawings.

### BRIEF DESCRIPTION OF THE DRAWINGS

FIG. 1 is a side elevational view of a portion of a vehicle including a door having a trim panel assembly manufactured in accordance with this invention.

FIG. 2 is an enlarged perspective view of the vehicle door illustrated in FIG. 1 including the trim panel assembly of this invention.

FIG. 3 is a further enlarged perspective view of a first embodiment of a first trim panel that can be used to manufacture the trim panel assembly illustrated in FIG. 1.

FIG. 4 is a side elevational view of the first embodiment of the first trim panel illustrated in FIG. 3 disposed within a molding die, wherein portions of the first embodiment of the first trim panel and the molding die define a mold cavity.

FIG. 5 is a side elevational view similar to FIG. 4 showing a molding material that has been introduced into the mold cavity to form a second trim panel.

FIG. 6 is a perspective view showing the first embodiment of the first trim panel and the second trim panel after being removed from the molding die to form a first embodiment of a trim panel assembly.

FIG. 7 is a side elevational view similar to FIG. 5 showing the first embodiment of the first trim panel and the second trim panel disposed within a cooling die.

FIG. 8 is an enlarged perspective view of a second embodiment of a first trim panel that can be used to manufacture the trim panel assembly illustrated in FIG. 1.

FIG. 9 is a perspective view, partially broken away for clarity, showing the second embodiment of the first trim panel and the second trim panel after being removed from the cooling die to form a second embodiment of a trim panel assembly.

### DETAILED DESCRIPTION OF THE PREFERRED EMBODIMENTS

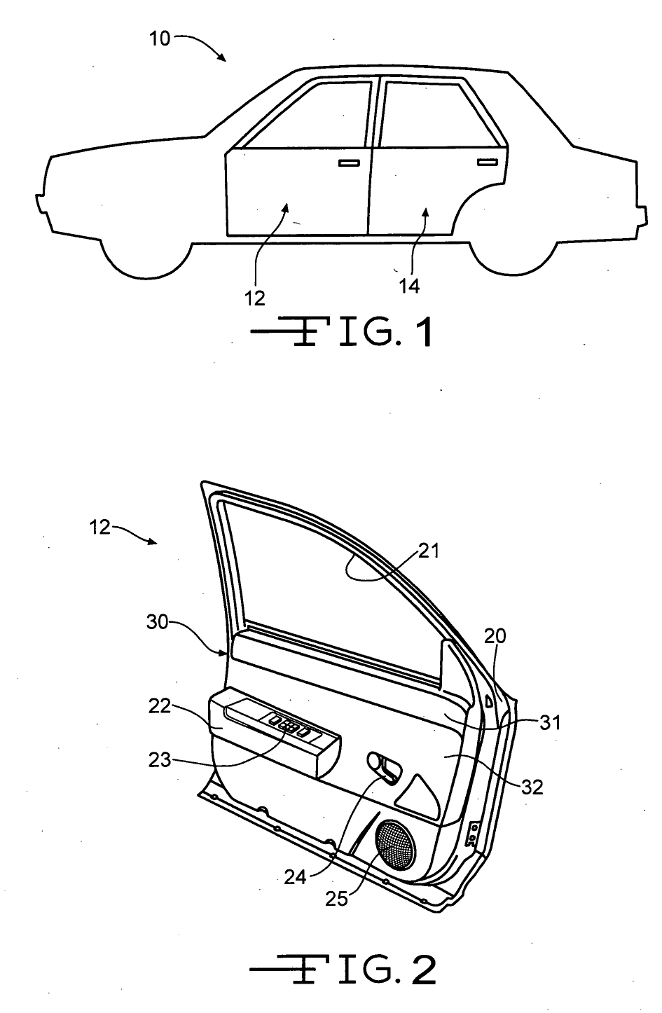

Referring now to the drawings, there is illustrated in FIG. 1 a portion of a vehicle, indicated generally at 10, in accordance with this invention. The illustrated vehicle 10 is, in large measure, conventional in the art and is intended merely to illustrate one environment in which this invention may be used. Thus, the scope of this invention is not intended to be limited for use with the specific structure for the vehicle 10 illustrated in FIG. 1 or with vehicles in general. On the contrary, as will become apparent below, this invention may be used in any desired environment for the purposes described below. The illustrated vehicle 10 is a conventional passenger sedan that includes a pair of front passenger doors, one of which is illustrated generally at 12, and a pair of rear passenger doors, one of which is illustrated generally at 14. However, it will be appreciated that this invention may be utilized in connection with any type of vehicle.

The structure of one of the front doors 12 illustrated in more detail in FIG. 2. As shown therein, the door 12 includes a door frame 20 that defines the general shape of the door 12 and has an opening 21 formed therethrough for a window (not shown). A variety of components can be attached to the door 12 for use by passengers within the vehicle 10. These components can include, for example, a console 22 that supports a plurality of control switches 23. The control switches 23 may control the operation of windows, door locks exterior rear view mirrors, sunroofs, audio systems, and the like within the vehicle 10. The door 12 may also include a handle 24 for facilitating the opening thereof and one or more audio speakers 25.

A portion of the side of the door frame 20 that faces toward the interior or passenger compartment of the vehicle 10 is covered by a trim panel assembly, indicated generally at 30. The structure of the trim panel assembly 30 and the method of manufacturing same will be described in detail below. The trim panel assembly 30 is provided for both aesthetic and functional purposes. The trim panel assembly 30 is preferably provided with an aesthetically pleasing appearance in order to enhance the interior appearance of the vehicle 10. The trim panel assembly 30 is adapted to cover various conventional operating mechanisms (not shown) that are supported on or otherwise contained within the door frame 12, such as door opening linkages, wiring, electrical controls, and the like. The trim panel assembly 30 can also be used to support some or all of the components discussed about, including console 23, the handle 24, and the audio speaker 25.

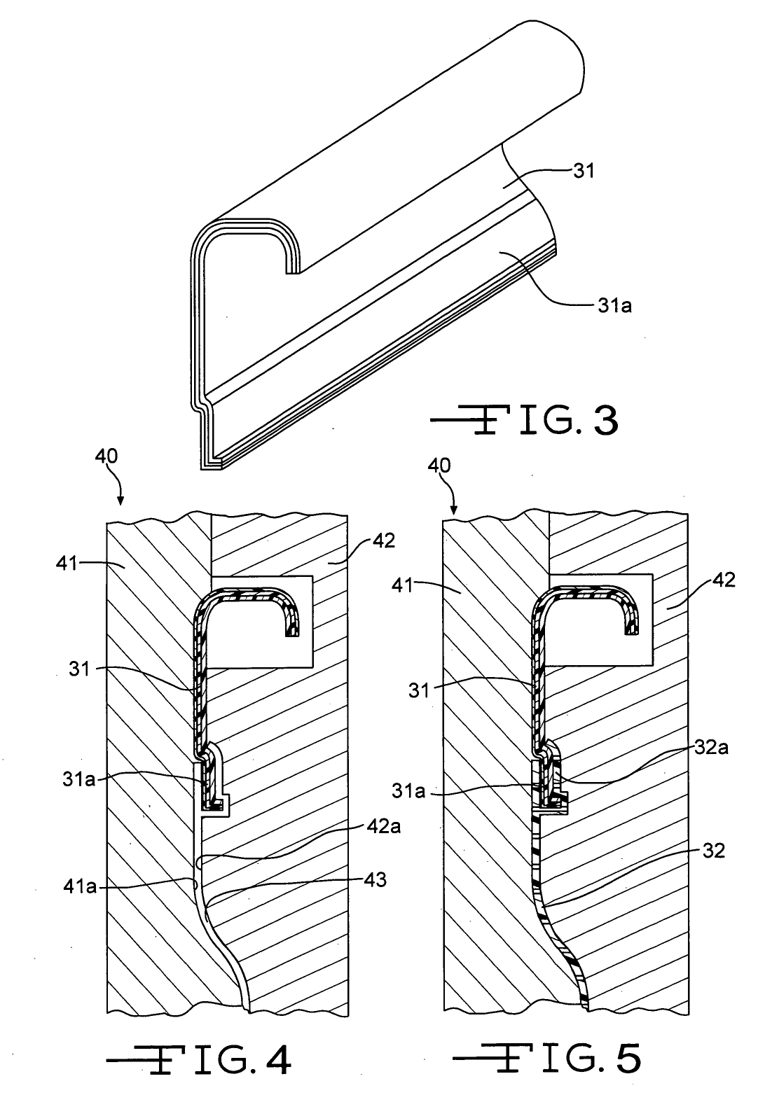

The structure and method of manufacture of the trim panel assembly 30 is illustrated in FIGS. 3 through 7. Initially, as shown in FIG. 3, a first embodiment of a first trim panel 31 is provided. The first trim panel 31 is preferably formed from a generally flat panel of material having a desired shape. In the illustrated embodiment, the first trim panel 31 is formed from a generally flat panel of material having an inverted-J shape. However, the first trim panel 31 may be formed having any other desired shape. If desired, the first trim panel 31 may be formed from a laminate of a plurality of layers of different materials, such as shown in FIG. 3. For example, the first trim panel 31 can include a first layer formed from an acrylonitrile butadiene styrene, polypropylene, or other material that is covered by a second layer formed from a vinyl, fabric, or soft foam material. The first trim panel 31 includes an attachment portion 31a that facilitates the engagement of a second trim panel 32 thereto in the manner described in detail below. The attachment portion 31a of the first trim panel 31 may have any desired shape to accomplish this. In the illustrated embodiment, a single attachment portion 31 a extends continuously throughout the length of the first trim panel 31. However, the attachment portion 31 a of the first trim panel 31 may have any other desired shape or combination of shapes. Furthermore, the attachment portion 31a may be formed from a plurality of discrete portions that extend along the length of the first trim panel 31.

As shown in FIG. 4, the first trim panel 31 is disposed within a molding die, indicated generally at 40. The molding die 40 is conventional in the art and includes first and second die sections 41 and 42. The first and second die sections 41 and 42 are supported for movement relative to one another between opened and closed positions. The first and second die sections 41 and 42 have respective recesses 41a and 42a formed therein that together define a die cavity 43. When moved to the open position, the first and second die sections 41 and 42 are spaced apart from one another to allow the first trim panel 31 to be inserted within the die cavity 43. When moved to the closed position, the die sections 41 and 42 engage one another to enclose the first trim panel 31 within the die cavity 43. In particular, when the first trim panel 31 is disposed within the molding die 40, the attachment portion 31a of the first trim panel 31 is disposed within the die cavity 43, as shown in FIG. 4.

Next, as shown in FIG. 5, a molding material 32 is injected or otherwise introduced within the die cavity 43 so as to extend about the attachment portion 31a of the first trim panel 3 1. The molding material 32 can be formed from any desired material. For example, the molding material can be formed from polypropylene, thermoplastic polyolefin, thermoplastic elastomer, acrylonitrile butadiene styrene, or any other material that is suitable for the second trim panel 32. Following injection into the die cavity 43, the molding material 32 is maintained within the molding die 40 until it hardens sufficiently to become dimensionally stable. At that point, the trim panel assembly 30, including the first trim panel 31 and the second trim panel 32, can be removed from the molding die 40, as shown in FIG. 6.

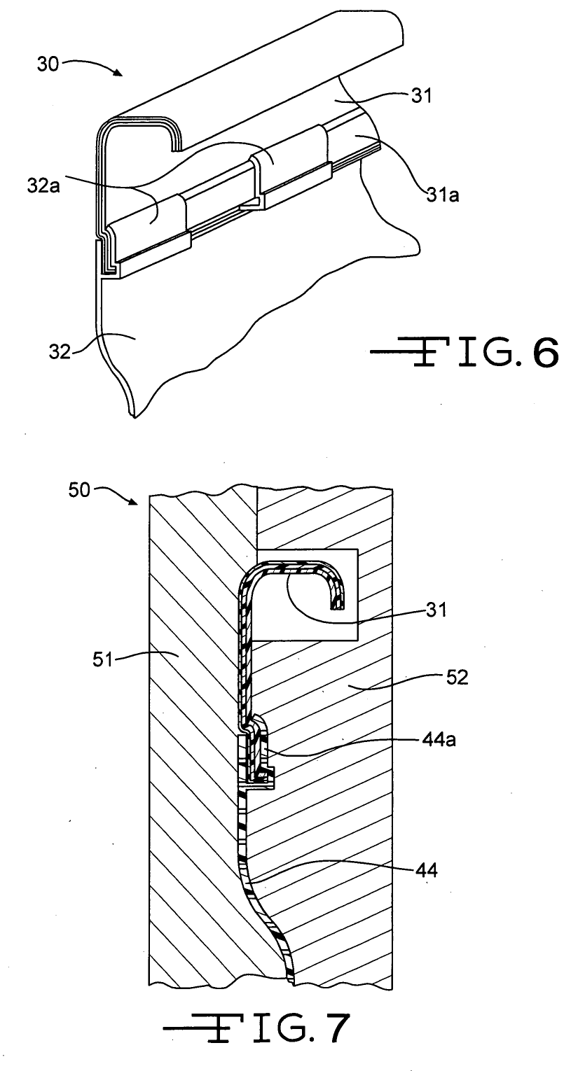

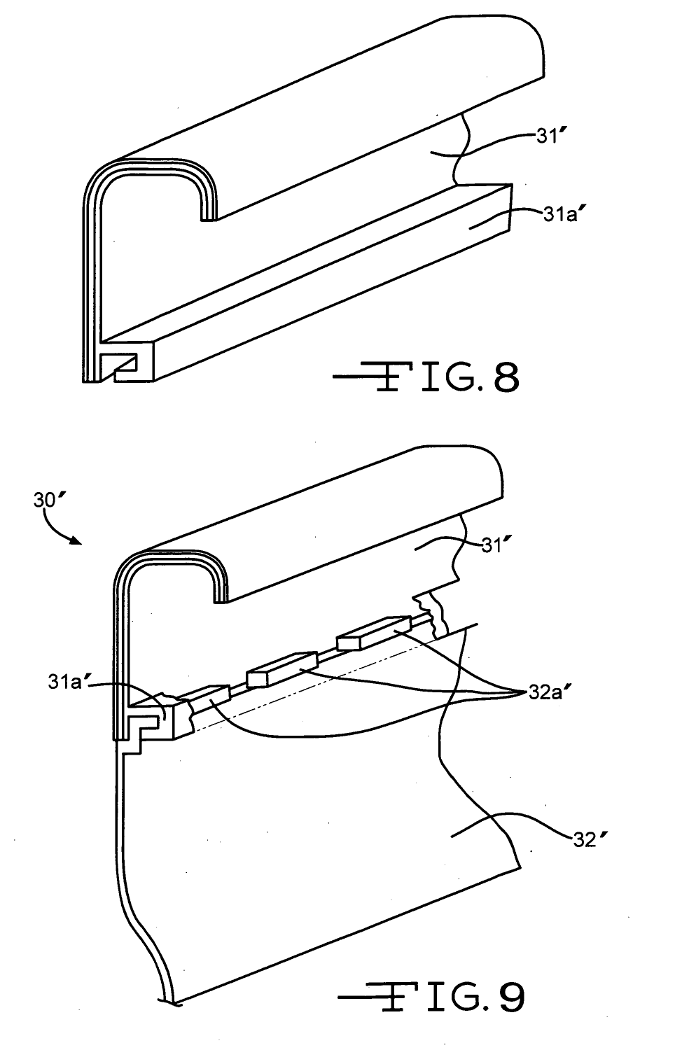

Thereafter, as shown in FIG. 7, the trim panel assembly 30 can be disposed within a cooling fixture, indicated generally at 50. The cooling fixture 50 is conventional in the art and includes first and second cooling sections 51 and 52. The first and second cooling sections 51 and 52 are supported for movement relative to one another between opened and closed positions. When moved to the open position, the first and second cooling sections 51 and 52 are spaced apart from one another to allow the trim panel assembly 30 to be inserted therebetween. When moved to the closed position, the first and second cooling sections 51 and 52 engage the trim panel assembly 30. The first and second cooling sections 51 and 52 are adapted to draw heat away from the second trim panel 32 so as to expedite the cooling thereof to a final desired temperature.

As best shown in FIG. 6, the molding die 40 is configured to provide the second trim panel 32 with an attachment portion 32a that connects the second trim panel 32 to the first trim panel 3 1. The attachment portion 32a of the second trim panel 32 may have any desired shape to accomplish this. In the illustrated embodiment, a plurality of discrete attachment portions 32a extends along the length of the second trim panel 32. However, the attachment portion 32a of the second trim panel 32 may have any other desired shape or combination of shapes. Furthermore, the attachment portion 32a may be formed from a single portion that extends throughout the length of the second trim panel 32. In this first embodiment of the invention, the attachment portion 32a of the second trim panel 32 is molded about the attachment portion 31a of the first trim panel 31.

The attachment portion 32a of the second trim panel 32 also engages the attachment portion 31a of the first trim panel 31 for relative sliding movement therebetween. This ability to accommodate relative sliding movement is desirable because during the cooling process described above, the second trim panel 32 may change slightly in dimension relative to the first trim panel 31. Without the ability to accommodate relative sliding movement between the attachment portion 31a of the first trim panel 31 and the attachment portion 32a of the second trim panel 32, such dimensional changes during the cooling process might cause undesirable warping of either or both of the first and second trim panels 31 and 32. If desired, the attachment portion 31a of the first trim panel 31 can be provided with a coating of a conventional anti-seize material (not shown) prior to being disposed within the molding die 40. The anti-seize material facilitates relative sliding movement between the first trim panel 31 and the second trim panel 32 during cooling of the second trim panel 32.

FIGS. 8 illustrates a second embodiment of a first trim panel 31′ that can be used to form a second embodiment of a trim panel assembly, indicated generally at 30′ in FIG. 9. The second embodiment of the first trim panel 31′ includes an attachment portion 31a′. The second embodiment of the first trim panel 31′ can be disposed within a molding die (not shown) similar to the molding die 40 described above, and a second embodiment of a second trim panel 32′ can be molded thereto in the manner described above. The second embodiment of the second trim panel 32′ includes a plurality of discrete attachment portions 32a′ similar to those described above. In this second embodiment of the invention, the attachment portions 32a′ of the second trim panel 32′ are molded within the attachment portion 31a′ of the first trim panel 31′.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

What is claimed is:

1. A trim panel assembly comprising:
a first trim panel having an attachment portion; and
a second trim panel having an attachment portion that cooperates with the attachment portion of the first trim panel to connect the first and second trim panels together to provide a trim panel assembly that allows relatively sliding movement between the first and second trim panels.

2. The trim panel assembly defined in claim 1 wherein the first trim panel is formed from a laminate of a plurality of layers of different materials.

3. The trim panel assembly defined in claim 1 wherein the first trim panel is provided with a single attachment portion that extends continuously throughout the length thereof.

4. The trim panel assembly defined in claim 3 wherein the second trim panel is provided with a plurality of discrete portions that extends along the length thereof.

5. The trim panel assembly defined in claim 1 wherein the attachment portion of the second trim panel is molded about the attachment portion of the first trim panel.

6. The trim panel assembly defined in claim 1 wherein the attachment portion of the second trim panel is molded within the attachment portion of the first trim panel.

7. The trim panel assembly defined in claim 1 wherein the first trim panel is provided with a plurality of discrete portions that extends continuously throughout the length thereof.

8. The trim panel assembly defined in claim 7 wherein the second trim panel is provided with a single attachment portion that extends along the length thereof.

9. The trim panel assembly defined in claim 7 wherein the attachment portion of the second trim panel is molded about the attachment portion of the first trim panel.

10. The trim panel assembly defined in claim 7 wherein the attachment portion of the second trim panel is molded within the attachment portion of the first trim panel.

11. A method of manufacturing a trim panel assembly comprising the steps of:
(a) providing a first trim panel having an attachment portion;
(b) disposing the attachment portion of the first trim panel within a mold cavity; and
(c) introducing a material into the mold cavity so as to provide a second trim panel having an attachment portion that cooperates with the attachment portion of the first trim panel to connect the first and second trim panels together to provide a trim panel assembly and to allow relatively sliding movement between the first and second trim panels.

12. The method defined in claim 11 wherein said step (a) is performed by providing the first trim panel from a laminate of a plurality of layers of different materials.

13. The method defined in claim 11 wherein said step (a) is performed by providing the first trim panel with a single attachment portion that extends continuously throughout the length thereof.

14. The method defined in claim 13 wherein said step (c) is performed by providing the second trim panel with a plurality of discrete portions that extends along the length thereof.

15. The method defined in claim 11 wherein said step (c) is performed by molding the attachment portion of the second trim panel about the attachment portion of the first trim panel.

16. The method defined in claim 11 wherein said step (c) is performed by molding the attachment portion of the second trim panel within the attachment portion of the first trim panel.

17. The method defined in claim 11 wherein said step (a) is performed by providing the first trim panel with a plurality of discrete portions that extends continuously throughout the length thereof.

18. The method defined in claim 17 wherein said step (c) is performed by providing the second trim panel with a single attachment portion that extends along the length thereof.

19. The method defined in claim 17 wherein said step (c) is performed by molding the attachment portion of the second trim panel about the attachment portion of the first trim panel.

20. The method defined in claim 17 wherein said step (c) is performed by molding the attachment portion of the second trim panel within the attachment portion of the first trim panel.
